(19) United States
(12) Patent Application Publication
(10) Pub. No.: US 2010/0179914 A1
(43) Pub. Date: Jul. 15, 2010

(54) MARKING OF PRODUCTS

(75) Inventors: Ron J. Levin, Charlotte, NC (US); Dwight Pakan, Charlotte, NC (US); Greg Coughlin, Springfield, NJ (US)

Correspondence Address: FISH & RICHARDSON P.C., P.O BOX 1022, Minneapolis, MN, 55440-1022, US

(73) Assignee: BASF SE, Rheinland-Pfalz (DE)

(21) Appl. No.: 12/633,424

(22) Filed: Dec. 8, 2009

Related U.S. Application Data
(60) Provisional application No. 61/120,694, filed on Dec. 8, 2008.

(51) Int. Cl. G06Q 99/00; G06K 7/10

(52) U.S. Cl. 705/318; 235/375

(57) ABSTRACT

A method of marking an individual product with a unique code. The method can include associating the product with an indicia comprising photoactive, reflective or electromagnetic particles or combinations thereof or one or more photoactive, reflective or electromagnetic films or substrates that includes a random physical property, measuring the random physical property, and marking the product with the measured value that is specific to the product, optionally in combination with a barcode, RFID tag, lot number or the like for the product.

### CROSS-REFERENCE TO RELATED APPLICATIONS

This application claims priority to U.S. Provisional Application No. 61/120,694, filed Dec. 8, 2008, which is incorporated herein by reference in its entirety.

### TECHNICAL FIELD

This disclosure relates to marking of a product for verification with an indicia that has a measurable random physical property.

### BACKGROUND

Counterfeiting is one of the most significant sources of loss in many industries including the automotive, aviation, pharmaceutical, entertainment, consumer electronics, medical device, retail, and IT sectors. Counterfeiting can result in consumers obtaining inferior products instead of the products the consumers expect. In many applications such as pharmaceutical, food product, medical device, automotive and aviation applications, these inferior products can lead to injury and, in some cases, fatality. Thus, it is desirable to allow consumers to positively confirm the authenticity of products before purchase.

One approach to authenticating a product is to use holograms or other tamper evident packaging. For example, holographic labels may be applied to pharmaceuticals, licensed consumer products, apparel and other high value consumer and industrial products. Such labels, if tampered with, can become permanently damaged, leaving a visible footprint on the products.

A disadvantage with holograms as security devices is that they can be copied by using a holographic recording process. Then if the counterfeiter has the technology to create a hologram on a counterfeit surface, the counterfeiter can create a counterfeit part with a hologram just like the genuine part. Another disadvantage is that a counterfeiter can easily view and analyze the marking. Furthermore, it is nearly impossible for a consumer to know with certainty that a hologram on a package of a product that the consumer purchased contains an official image that a brand owner uses as its hologram image.

### SUMMARY

In one aspect, a method of marking an individual product can include associating an individual product with an indicia with a measurable random physical property that has photoactive, reflective or electromagnetic particles or combinations thereof or one or more photoactive, reflective or electromagnetic films or substrates. The method can also include measuring a value corresponding to the random physical property. The method further can include assigning the measured value to the individual product.

In some implementations, the photoactive particles can include high aspect ratio pigments. In some implementations, the reflective particles can include hemispherically coated solid glass spheres. In some implementations, the electromagnetic particles can include high aspect ratio, magnetically active particles.

In some implementations, the indicia can include one or more light reflective markings that have a random reflection wavelength, a random transmission wavelength, a random orientation, a random dimension, a random shape, a random number of regular and/or random shapes, a random color value, a random metamerism, a random distribution and/or concentration of reflective particles, a random distribution and/or concentration of misting fibers, random colors, and the like. The indicia can be printed, laminated, coated or otherwise incorporated on or into a paper, flexible film, or paperboard packaging of the individual product. The indicia can also be provided on the individual product itself. Further, the indicia can be printed on a label or be part of the labelstock itself that is to be attached to the individual product or packaging of the individual product.

In some implementations, the measured value that corresponds to the random physical property of the indicia can be combined with a barcode, RFID tag, lot number or other tracking device for the individual product to create a unique product serial number. In some embodiments, the method can include taking a picture or scan, or irradiating the indicia on a product to be verified, processing the resulting image to obtain a value of a random physical property of the indicia, and comparing the value obtained with a value on record for product verification.

In another aspect, a method of confirming that a product to be tested is a particular product can include providing on the particular product or on packaging for the particular product an indicia with a measurable random physical property where the indicia has photoactive, reflective or electromagnetic particles or combinations thereof or one or more photoactive, reflective or electromagnetic films or substrates. The method can also include determining a value that corresponds to the random physical property of the indicia. The method further can include assigning the value to the particular product. The method can additionally include determining a value for the product to be tested using the method used in said previous determining step. The method can also include comparing the value for the product to be tested to the value for the particular product to verify that the test product is the particular product.

In various implementations, the method can include shipping the particular product to a shipping location and determining the value for the product to be tested at the shipping location. The method can also include incorporating the indicia on the particular product or on the packaging for the particular product and scanning the indicia to determine the value corresponding the random physical property of the indicia. In some embodiments, the indicia can include one or more light reflective markings that have a random reflection and/or transmission wavelength, a random orientation, a random dimension, a random shape, a random number of regular and/or random shapes, a random color value, a random metamerism, a random distribution and/or concentration of reflective particles, a random distribution and/or concentration of misting fibers, random colors, and the like.

The details of one or more embodiments are set forth in the accompanying description below. Other features, objects, and advantages will be apparent from the description, and from the claims.

### BRIEF DESCRIPTION OF THE DRAWINGS

FIG. 1 illustrates a label that includes a bar code and a target area that corresponds to a random value.

FIG. 2 illustrates a stripe that includes a pigment and is provided on a pressure sensitive adhesive label.

FIGS. 3A and 3B illustrate die cut circles provided from the label in FIG. 2 and randomly spun to provide random angles.

FIGS. 4A and 4B illustrate die cut rectangles provided from the label in FIG. 2 and provided at random angles.

FIGS. 5A and 5B illustrate the die cut rectangles provided from FIGS. 4A and 4B and further including a bar code corresponding to a serial number.

FIG. 6 illustrates a OEM label and rectangular label (such as those provided in FIGS. 5A or 5B) that may be provided, e.g., on product packaging.

### DETAILED DESCRIPTION

The term “comprising” and variations thereof as used herein are used synonymously with the term “including” and variations thereof and are open, non-limiting terms.

A method of marking an individual product is described that can include associating an individual product with an indicia with a measurable random physical property that has randomly distributed and/or oriented, photoactive, reflective or electromagnetic particles or combinations thereof or one or more photoactive, reflective or electromagnetic films or substrates. The method can also include measuring a value corresponding to the random physical property. The method further can include assigning the measured value to the individual product.

The method of the invention allows an individual or particular product to be assigned its own value. Thus, even though there may be a large number of identical products in a particular shipment, each individual or particular product within the shipment will have its own value corresponding to the indicia on that individual or particular product. This makes copying the indicia much more difficult for a potential counterfeiter.

The indicia can include photoactive, reflective or electromagnetic particles or combinations thereof. Representative examples of suitable photoactive particles can include particles of transition metal compounds such as TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, and combinations thereof Representative examples of suitable reflective particles can include glitter, sequins, confetti, metallic flakes, glass spheres, metallic or non-metallic micas, bismuth oxychloride, guanines (i.e., fish scales), coated particulate substrates, polymeric flakes (e.g. mylar), polymeric spheres (e.g., polystyrene spheres), polymeric film pieces, ribbons, or tape, and combinations thereof Representative examples of suitable electromagnetic particles can include particles prepared from electromagnetic compounds and metals or alloys such as gamma ferric oxide, acicular magnetite, cobalt-modified or adsorbed ferric oxide, berthollide ferric oxide, chromium dioxide, metals or alloys (such as stainless steel, Fe—Co, Fe—Ni, Fe—Co—Ni, Co—Ni, Co—Cr and Fe—Co—V alloys), and combinations thereof.

The photoactive, reflective or electromagnetic particles can be randomly oriented and/or distributed to provide a random physical property. In some implementations, the photoactive particles can include high aspect ratio pigments. In some implementations, the reflective particles can include hemispherically coated solid glass spheres. In some implementations, the electromagnetic particles can include high aspect ratio, magnetically active particles. In some embodiments, the aspect ratio for the high aspect ratio pigments or particles is about 1 to 5. In some embodiments, the aspect ratio is about 1 to 10. In some embodiments, the aspect ratio is about 1 to 25.

In some implementations, the indicia can include one or more films. In some embodiments, the indicia can include one or more photoactive, reflective or electromagnetic films and the one or more photoactive, reflective or electromagnetic films can include a nano-stratified film. In some embodiments, the nano-stratified film can be iridescent and can include multiple film nano-layers using two or more polymers having differing indices of refraction. The film layers can vary in their thicknesses and in the amount of the polymers used in the layers to provide random properties and can also include imperfections that provide these properties. Such films can, for example, reflect light at random wavelengths. In some implementations, the films can include one or more photoactive, reflective or electromagnetic particles. In some implementations, the indicia can include one or more photoactive, reflective or electromagnetic substrates that can further include one or more photoactive, reflective or electromagnetic films and/or one or more photoactive, reflective or electromagnetic particles.

In some implementations, the indicia can include at least one light reflective marking with visible colorants, near visible pigments, and/or fluorescent dyes. The light reflective marking can have a measurable random physical property. For example, the light reflective marking can have a random reflection and/or transmission wavelength. The light reflective marking can have a random orientation. One example is a label having one or more color stripes where the stripe(s) is oriented (e.g. rotated or spun) randomly from an initial position, e.g., to provide a particular angle. The light reflective marking can have a random dimension. One example is a label having one or more color stripes where the thickness of the stripe(s) is chosen by randomly scaling from a predetermined thickness. The light reflective marking can have a random shape. One example is that the shape of the marking is obtained by a random distortion of a predetermined shape. The light reflective marking can have a random number of shapes (e.g., regular shapes including squares, rectangles, stripes, circles, ovals, etc., and/or random shapes that can be obtained from random distortion). These shapes can be arranged in a regular and/or random pattern. The light reflective marking can have a random color value (e.g., brightness or contrast). The random color value can be randomly selected from a database that has a vast amount of different color values. The random color value can be caused by a random distribution and/or concentration of the dye particles present in the light reflective marking. The light reflective marking can have a random metamerism where the color of the marking is randomly matched with the apparent color of a selected object having a different spectral power distribution. The light reflective marking can have a random distribution and/or concentration of fluorescent markers. The light reflective marking can have a random distribution and/or concentration of misting fibers that may be used to mist the dye and then incorporated in a paper. The light reflective marking can have random colors that can be created, e.g., by controlling ink being shot from an inkjet printer. Furthermore, any of the random properties described herein can be used in combination.

In some implementations, the indicia can be provided on packaging of the product. For example, when the product is packaged with paper, flexible film or paperboard, the indicia can be directly printed on the paper or paperboard packaging of the product using, for example, an inkjet printer. For example, the indicia can be printed on a paperboard or cardboard box used as packaging or to transport a product.

In some implementations, the indicia can be provided on the product itself. For example, the indicia can be directly printed on the product. The indicia can also be coated on the product. Further, the indicia can be incorporated into the product.

In some implementations, the indicia can be printed or otherwise incorporated on a label to be affixed to the product or to packaging for the product.

In some implementations, the indicia can be scanned to measure the value that corresponds to the random physical property.

In some implementations, the measured value corresponding to the random physical property can be combined with a barcode, RFID tag, lot number or the like to identify the product.

In some implementations, a device such as a scanner can be used to verify that the random property of the indicia matches the predetermined random property of the indicia on record for the product. Alternately, a picture of an indicia to be verified can be taken with a camera or other suitable devices, the picture processed to obtain a value of a random physical property of the indicia, and the value obtained compared to the value on record for the product so as to verify the authenticity of the product.

In some implementations, one or more stripes with visible colorants or near visible pigments can be printed on a sheet of pressure sensitive adhesive label. The label sheet can then be die cut into circular pieces or other shapes that have the color stripe(s). The circular pieces can be spun randomly relative to an initial position and then die cut into rectangles or other shapes where the color stripe(s) have random angles with respect to the initial position. These random angles can be measured by optical scanners or other suitable devices as numerical values. Barcodes can also be applied onto the rectangular labels with the randomly oriented color stripe(s). The barcode numbers and the random angle values can be combined in an indexed database. The rectangular labels can then be attached to products or packaging of the products, optionally along with barcode labels that have product serial numbers provided by product manufacturers. Before a customer purchases a particular product, the customer can take a picture or otherwise create an image of the product with the label(s) and then upload the image to a product verification website via a secure network. The image can then be analyzed using specialized computer software to match the readings of manufacturer product serial number, barcode for color label, and random physical property value (in this case, the random angle of the color stripe(s)) with the corresponding values stored in the database. Any mismatch can yield a message to the customer or product manufacturer that a product is a counterfeit product. Comparable methods can be used for the other random properties described herein.

In some implementations, the indicia can include at least one light reflective marking that has a random distribution and/or concentration of dye particles. In some implementations, the measured value corresponds to color intensity created by the randomly distributed dye particles.

Compositions such as dispersions including reflective particles such as dye particles can be used for brand protection. Reflective particles can include any particles that are capable of reflecting light in the visible light, IR or UV range. The compositions can be incorporated into a branded product itself or the package of the product, or added as a coating, for example, in the form of a light reflective marking. For example, a light reflective marking such as a color marking can be printed on paperboard (cardboard), films or paper packaging or on a label using, for example, an inkjet printer. The color marking can have any suitable colors within the visible wavelength. In some embodiments, the light reflective marking reflects light in the near infrared (IR) range (e.g., at a wavelength range of 750 nm to 1 millimeter). In some embodiments, the light reflective marking can fluoresce or reflect light in the IR range (e.g., a wavelength range of 750 nm to 1 m). When the compositions are used to mark products, random fluctuations in the amount of the reflective particles used may exist from product to product. This may be caused by inconsistent coatings and/or non-uniform distribution of the reflective particles. These random fluctuations can help provide a way of creating a code for a product that is unique to that product.

For example, at the time of packaging, a product marked with a random amount of reflective particles can be read by a scanner that can measure the light wavelength reflected by the reflective particles and the strength of the reflective particles, and return the measured wavelength and strength data as numerical values. The returned numerical values can correlate to the randomness of the amount of reflective particles used. The returned numerical values can optionally be combined with a barcode number for the product that can be read by the same scanner or another scanner to create a serial number for the product. The product labeled with this serial number can then be verified as genuine by re-measuring the data at the destination. Further, this product serial number can be integrated with customer supply chain data to build an indexing database that allows customers to track individual items through their value chain. In some embodiments, a customer can use a camera including a cell phone camera or a LED device that can read the near visible spectrum to take a picture of the light reflective marking on the product and then upload the picture to a website for product confirmation.

The product serial numbers created as described herein typically vary between two units that are successively marked with the same composition. This makes it virtually impossible to systematically duplicate the product serial numbers. To duplicate a product serial number where part of the value is a measured value of the reflective particles used, one would have to know the actual serial number, the actual measured colorant value for that serial number, and then create a perfect mark that resembles the original mark on the product. Even this would only duplicate one unit. Thus the brand protection methods described herein provide anti-counterfeiting protection that can be extremely difficult to duplicate. These methods can allow brand owners to prevent counterfeiting and control gray market activities and allow better inventory control in general. Specifically, brand owners can advantageously detect the presence of counterfeits or gray market materials in their supply chain and determine the source of these contraband materials.

In some embodiments, the reflective particles can include encapsulated dye microparticles described in the commonly owned U.S. patent application Ser. No. 11/569,679, the entire disclosure of which is herein incorporated by reference. The encapsulated dye microparticles can be obtained by (i) polymerization of at least one water-soluble monoethylenically unsaturated monomer in the presence of at least one ethylenically unsaturated monomer having at least two double bonds by inverse water-in-oil suspension polymerization wherein doped nanoparticles are used as a suspending medium; (ii) emulsion polymerization of at least one water-insoluble monoethylenically unsaturated monomer with from 0 to 10% by weight, based on total monomer weight, of at least one ethylenically unsaturated monomer having at least two double bonds wherein doped nanoparticles are used as an emulsifier; (iii) free radical polymerization of at least one ethylenically unsaturated monomer with a copolymerizable dye that has an ethylenically unsaturated double bond; (iv) agglomeration of at least two different groups of dye particles that differ in their absorption, emission and/or scattering of electromagnetic radiation to form aggregates; or (v) polymerization of at least one ethylenically unsaturated monomer in the presence of dyes and/or nanoparticles (such as those used in (i) or (ii)) that can be doped with a dye, a rare earth element or a compound thereof, a radioactive element or a compound thereof, or a combination thereof

The encapsulated dye microparticles can be prepared by (i) polymerization of at least one water-soluble monoethylenically unsaturated monomer in the presence of at least one ethylenically unsaturated monomer having at least two double bonds by inverse water-in-oil suspension polymerization where doped nanoparticles are used as a suspending medium.

The microparticles prepared according to (i) are virtually water-insoluble polymer particles. In some embodiments, the solubility of the polymer particles in water is less than about 1 g/l at 20° C. In some embodiments, the solubility of the polymer particles in water is less than about 0.1 g/l at 20° C.

In some embodiments, the microparticles have a mean particle diameter of about 0.1 μm to about 1000 μm. In some embodiments, the microparticles have a mean particle diameter of about 0.5 μm to about 50 μm. In some embodiments, the microparticles have a mean particle diameter of about 1 μm to about 20 μm. The preparation of particulate polymers by the method of inverse water-in-oil suspension polymerization (ISP) where nanoparticles are used as a suspending medium is disclosed, for example, in U.S. Pat. No. 2,982,749, column 1, line 21 to column 6, line 34. Representative examples of suitable suspending media that have a low hydrophilic-lipophilic balance (HLB) include silanized silicas, bentonites or clays, each of which have been treated with quaternary ammonium compounds, and organic nanoparticles, such as partly sulfonated polyvinyltoluene or chlorovinyltoluene polymers reacted with dimethylamine. In some embodiments, the suspending media have a HLB value of less than about 7. In some embodiments, the suspending media have a HLB value of less than about 4. For the definition of the HLB value, see, e.g., W. C. Griffin, Journal of the Society of Cosmetic Chemists, Volume 1, 311 (1950). Representative examples of nanoparticles that are suitable for use as suspending media include CaCC₃, BaSO₄, barium titanate, SiO₂, oxides, sulfides, phosphates and pyrophosphates of alkaline earth metals and transition metals, in particular zinc oxide, titanium dioxide, iron oxide (goethite, hematite), iron sulfide and barium pyrophosphate, and furthermore polymer particles, for example of polystyrene or polyacrylates, and mixtures of two or more nanoparticles, for example mixtures of zinc oxide and titanium dioxide. In some embodiments, the nanoparticles have a mean particle diameter of about 5 nm to about 500 nm. In some embodiments, the nanoparticles have a mean particle diameter of about 20 nm to about 300 nm.

In some embodiments, the nanoparticles used in (i) are doped, prior to the polymerization, with a dye, a rare earth element or a compound thereof, or a radioactive element or a compound thereof. Even very small amounts of doping may enable an identification of the doped particles with the aid of the determination of the absorption, emission or scattering of electromagnetic radiation. In some embodiments, the nanoparticles are doped with at least one fluorescent dye. For example, nanoparticles of polystyrene having a mean particle diameter of about 20 nm to about 300 nm can be doped with a fluorescent dye. Nanoparticles of silica having a mean particle diameter of about 20 nm to about 100 nm can be doped with a fluorescent dye. Silica particles having said diameter can also be doped with lanthanum and/or terbium and/or cerium for stabilizing the emulsion in ISP.

Representative examples of suitable dyes include water-insoluble dyes, water-soluble dyes, and reactive dyes.

Representative examples of suitable water-insoluble dyes include Fluorol 7GA (Lambdachrome No. 5550—Lambda Chrom Laser Dyes from Lambda Physik GmbH, Hans-Bockler-Str. 12, Gottingen), Coumarin 47 (CAS Reg. No. 99-44-1), Coumarin 102 (CAS Reg. No. 41267-76-9), Coumarin 6H (CAS Reg. No. 58336-35-9), Coumarin 30 (CAS Reg. No. 41044-12-6), Fluorescein 27 (CAS Reg. No. 76-54-0), Uranin (CAS Reg. No. 518-47-8), Bis-MSB (CAS Reg. No. 13280-61-0), DCM (CAS Reg. No. 51325-91-8), Cresyl Violet (CAS Reg. No. 41830-80-2), Phenoxazon 9 (CAS Reg. No. 7385-67-3), HITCI (CAS Reg. No. 19764-96-6), I R 125 (CAS Reg. No. 3599-32-4), I R 144 (CAS Reg. No. 54849-69-3), HDITCI (CAS Reg. No. 23178-67-8), Carbostyryl 7 (Lambdachrome No. 4220—Lambda Physik GmbH), and Carbostyryl 3 (Lambdachrome No. 4350—Lambda Physik GmbH).

Representative examples of suitable water-soluble dyes include Rhodamine B (CAS Reg. No. 81-88-9), Rhodamine 101 (CAS Reg. No. 64339-18-0), Rhodamine 6G (CAS Reg. No. 989-38-8), Brillantsulfaflavin (CAS Reg. No. 2391-30-2), Rhodamine 19 (CAS Reg. No. 62669-66-3), Rhodamine 110 (CAS Reg. No. 13558-31-1), Sulforhodamine B (CAS Reg. 2609-88-3), Nile Blue (CAS Reg. 53340-16-2), Oxazine (CAS Reg. 62669-60-7), Oxazine 1 (CAS Reg. No. 24796-94-9), HIDCI (CAS Reg. No. 36536-22-8), Cryptocyanine (CAS Reg. No. 4727-50-8), Furan 1 (Lambdachrome No. 4260—Lambda Physik GmbH), Stilbene 3 (Lambdachrome No. 4200—Lambda Physik GmbH), and DASBTI (Lambdachrome No. 5280—Lambda Physik GmbH).

Representative examples of suitable reactive dyes include DACITC (CAS Reg. No. 74802-04-3), DMACA, SE (CAS Reg. No. 96686-59-8), 5-FAM, SE (CAS Reg. No. 92557-80-7), FITC ‘Isomer I’ (CAS Reg. No. 3326-32-7), and 5-TRITC; G isomer (CAS Reg. No. 80724-19-2). These dyes can react with NH groups.

In some embodiments, the nanoparticles are used as a stabilizer for the emulsion in an amount of about 0.01% to about 20% by weight. In some embodiments, the nanoparticles are used as a stabilizer for the emulsion in an amount of about 0.1% to about 5% by weight.

In some embodiments, the microparticles prepared according to (i) have the doped nanoparticles on the surface. The microparticles can be isolated from the suspension, for example by breaking the suspension or by removing the volatile solvents.

For an overview of the stabilization of emulsions with colloidal particles and further suspending media for the inverse water-in-oil suspension polymerization, see, e.g., R. Aveyard, B. P. Binks and J. H. Clint, Advances in Colloid and Interface Science, Volume 100-102, pages 503-546 (2003). For background on Picketing emulsions, see, e.g., E. Vignati and R. Piazza, Langmuir, Vol. 19, No. 17, 6650-6656 (2003).

Suitable water-soluble monoethylenically unsaturated monomers include ethylenically unsaturated C₃- to C₆-carboxylic acids, such as acrylic acid, methacrylic acid, crotonic acid, maleic acid, itaconic acid, vinyllactic acid, ethacrylic acid, acrylamido-2-methylpropanesulfonic acid, vinylsulfonic acid, styrenesulfonic acid, vinyltoluenesulfonic acid, and vinylphosphonic acid. The ethylenically unsaturated acids can be used in a form partly or completely neutralized with alkali metal or alkaline earth metal bases or with ammonia or ammonia compounds. In some embodiments, sodium hydroxide solution, potassium hydroxide solution or ammonia is used as the neutralizing agent. Suitable water-soluble monoethylenically unsaturated monomers also include acrylamide and methacrylamide. The water-soluble monoethylenically unsaturated monomers can be used alone or as a mixture with one another and together with up to about 20% by weight of water-insoluble monomers, such as acrylonitrile, methacrylonitrile or acrylates and methacrylates.

Ethylenically unsaturated monomers having at least two double bonds are used as crosslinking agents in ISP. Suitable ethylenically unsaturated monomers having at least two double bonds include N,N′-methylenebisacrylamide, divinylbenzene, divinyidioxane, acrylates and methacrylates of at least dihydric alcohols, such as ethylene glycol, propylene glycol, butylene glycol, hexanediol, glycerol, pentaerythritol and sorbitol, and polyalkylene glycols having molar masses M_{N} of 100 to 3000, in particular polyethylene glycol and copolymers of ethylene oxide and propylene oxide. In some embodiments, butane-1,4-diol diacrylate, butane-1,4-diol dimethacrylate, hexane-1,6-diol diacrylate, hexane-1,6-diol dimethacrylate, di- and triallyl ethers of pentaerythritol or sorbitan triallyl ether is used. In some embodiments, the ethylenically unsaturated monomers having at least two double bonds are used in an amount of about 0.01% to about 10% by weight based on the total amount of monomers used. In some embodiments, the ethylenically unsaturated monomers having at least two double bonds are used in an amount of about 0.5% to about 5% by weight based on the total amount of monomers used. Ethylenically unsaturated monomers having at least two double bonds can be used alone or as a mixture with one another.

The encapsulated dye microparticles can also be prepared by (ii) emulsion polymerization of at least one water-insoluble monoethylenically unsaturated monomer with from about 0% to about 10% by weight, based on total monomer weight, of at least one ethylenically unsaturated monomer having at least two double bonds where doped nanoparticles are used as an emulsifier.

The aqueous polymer dispersions prepared according to (ii) include the microparticles that are encapsulated with the doped nanoparticles and are dispersed in water. The encapsulated microparticles can be obtained from the aqueous polymer dispersions by centrifuging or destabilization of the dispersions by addition of inorganic salts.

In some embodiments, doped nanoparticles in the amounts used in (i) are used in (ii) for stabilizing the disperse phase. The resulting emulsion polymers can have the doped nanoparticles in or on the surface. Emulsion polymerization processes are known. Here, for example, water-insoluble monoethylenically unsaturated monomers are polymerized in the presence of free radical initiators, such as sodium persulfate, hydrogen peroxide or redox catalysts, to give a finely divided polymer dispersion. To stabilize the emulsion, compounds having an HLB value greater than about 7 are often used. Such compounds can include C₁₂- to C₁₈-alcohols which are reacted, for example, with about 5 to about 50 mole of ethylene oxide per mole of alcohol, or alkali metal salts of sulfonated long-chain (greater than C₁₂-) alcohols. Besides doped nanoparticles, additional emulsifiers can be used in (ii). In some embodiments, the amount of additional emulsifiers is about 0.1% to about 10% by weight, based on the monomers to be polymerized. In some embodiments, the amount of additional emulsifiers is about 0.5% to about 3% by weight, based on the monomers to be polymerized.

Water-insoluble monoethylenically unsaturated monomers include those ethylenically unsaturated compounds that form water-insoluble polymers. In some embodiments, the water solubility of the water-insoluble polymers is less than about 1 g/l. In some embodiments, the water solubility of the water-insoluble polymers is less than about 0.01 g/l. Representative examples of suitable water-insoluble monoethylenically unsaturated monomers include styrene, g-methylstyrene, esters of acrylic acid and methacrylic acid with monohydric C₁- to C₁₈-alcohols (e.g., C₁- to C₄-alcohols), acrylamides substituted by C₁- to C₂₀-alkyl groups and also N-substituted methacrylamides, such as N-methylacrylamide, N-methyl methacrylamide, N-ethylacrylamide and N-ethylmethacrylamide.

The water-insoluble monoethylenically unsaturated monomers can be copolymerized with small amounts of water-soluble ethylenically unsaturated monomers. The ethylenically unsaturated water-soluble monomers are used only in an amount such that the resulting polymers are water-insoluble. The water-soluble ethylenically unsaturated monomers can be used to modify the water-insoluble polymers. In some embodiments, the amount of water-soluble ethylenically unsaturated monomers used to modify the water-insoluble polymers is about 0.1% to about 10% by weight. In some embodiments, the amount of water-soluble ethylenically unsaturated monomers used to modify the water-insoluble polymers is about 0.2% to about 5% by weight. The water-soluble ethylenically unsaturated monomers that are used in (i) may be used in (ii), such as, in particular, ethylenically unsaturated acids. The water-soluble ethylenically unsaturated monomers are also used as crosslinking agents in (ii).

Representative examples of crosslinked emulsion polymers include polystyrenes that have been crosslinked with divinylbenzene or butanediol diacrylate, and acrylates and methacrylates that have been crosslinked with pentaerythrityl triacrylate and/or pentaerythrityl tetraacrylate, such as crosslinked poly(n-butyl acrylate) or crosslinked poly(methyl methacrylate).

Modification of the resulting emulsion polymers may be needed in order to introduce functional groups into the polymers so that they can be subjected to subsequent reactions. In some cases, it may be necessary to reduce the solubility of the polymers in water and to increase the strength properties of the polymers. This can be achieved by conducting the polymerization of the water-insoluble monoethylenically unsaturated monomers in the presence of ethylenically unsaturated monomers having at least two double bonds.

In some embodiments, the resulting polymer particles have a mean particle diameter of about 10 nm to about 1000 μm. In some embodiments, the polymer particles have a mean particle diameter of about 10 nm to about 10 μm. In some embodiments, the polymer particles have a mean particle diameter of about 500 nm to about 30 μm. In some embodiments, the polymer particles have a mean particle diameter of about 1 μm to about 10 μm.

Further, the encapsulated dye microparticles can be prepared by (iii) free radical polymerization of at least one ethylenically unsaturated monomer with a copolymerizable dye that has an ethylenically unsaturated double bond.

Representative examples of dyes that has an ethylenically unsaturated double bond include 4-(dicyanovinyl)julolidine (DCVJ) and trans-1-(2′-methoxyvinyl)pyrene. These dyes can be used in (i) and (ii) as co-monomers to encapsulate the polymer particles. When polymer particles having a mean particle diameter of about 5 nm to about 500 nm are obtained, it can be advantageous to agglomerate the particles into aggregates having a mean particle diameter of about 300 nm to 500 μm for use as encapsulated dye microparticles.

Moreover, the encapsulated dye microparticles can be prepared by (iv) agglomerating into aggregates at least two different groups of microparticles that differ in their absorption, emission and/or scattering of electromagnetic radiation. In some embodiments, the aggregates have a mean particle diameter of about 300 nm to 500 μm. In some embodiments, the aggregates have a mean particle diameter of about 400 nm to about 20 μm. Thus, for example, silica particles that are encapsulated with a fluorescent dye and have a mean diameter of about 5 nm to about 500 nm (e.g., about 20 nm to about 100 nm), and a crosslinked polystyrene that is modified with amino groups (e.g., about 0.5% to about 3% by weight of dimethylaminopropyl acrylate), has a mean particle diameter of about 20 nm to about 100 nm and is doped with one of the abovementioned reactive dyes, for example the dye having the CAS Reg. No. 96686-59-8, can be combined into an agglomerate, which has a mean particle size of about 300 nm to about 500 μm (e.g., about 400 nm to about 20 μm).

In some embodiments, the encapsulated dye microparticles include a mixture of two groups of microparticles where one group includes only one fluorescent dye and the other group includes two fluorescent dyes that differ from each other. In some embodiments, the encapsulated dye microparticles include a mixture of two groups of microparticles where one group includes only one fluorescent dye and the other group includes two reactive dyes that differ from each other. In some embodiments, the encapsulated dye microparticles include a mixture of two groups of microparticles where group A includes one fluorescent dye and group B includes three or more fluorescent dyes that differ from one another and from the dye of group A. In some embodiments, the encapsulated dye microparticles include a mixture of five different groups of microparticles where group A includes three different dyes D1, D2 and D3; group B includes the dyes D1 and D2; group C includes the dyes D1 and D3; group D includes two different dyes D4 and D5; and group E includes the dye D4.

When mixtures of two different groups of microparticles are used, a wide range of information can be obtained upon analyzing these mixtures, for example, with the aid of fluorescence microscopy. The information present in the mixtures can be read from the absorption, emission or scattering spectrum of the various fluorescent materials present in the mixtures with the aid of various methods that are known in the art. Some of these methods are described in the references cited herein.

Thus, a considerable amount of information can be provided by a combination of differently coded microparticles. For example, a combination of microparticles that are encapsulated with different fluorescent substances can be added to a product to be marked, for example, so that manufacturer, production location, date of manufacture and batch number can be detected from the absorption, emission or scattering spectrum of a sample of the marked product.

In addition, the encapsulated dye microparticles can be prepared by (v) polymerization of at least one ethylenically unsaturated monomer in the presence of dyes and/or nanoparticles that may be doped with at least one dye, a rare earth element or compound thereof, or a radioactive element or compound thereof. In some embodiments, the microparticles have a mean particle diameter of about 300 nm to about 500 μm. In some embodiments, the microparticles include a combination of at least two different groups of microparticles that differ in their absorption, emission and/or scattering of electromagnetic radiation.

The encapsulated dye microparticles described herein can be identified with the aid of commercial cytometers in which a fluorescence spectrometer and/or photodetectors having suitable filters are installed. The identification of the microparticles can be effected, for example, by analysis of the total fluorescence spectrum or of the emitted radiation of individual selected wavelengths or a range of wavelengths of the incident light.

When the encapsulated dye microparticles are used to mark a product, the microparticles should be compatible with the product to be marked, i.e., neither the desired product properties nor the redetectability of the microparticles should be impaired.

The following non-limiting examples describe further embodiments.

### Example 1

A marker is prepared comprising fluorescent particles or another pigment/dye and combined with a standard coating, e.g., a paper coating. The resultant coating is applied to a surface such as paper packaging or a label with a degree of precision that allows variability than can be measured. The resultant marker has a truly random application level that can be measured and combined with a serial number to create a unique identifier for a packaged product.

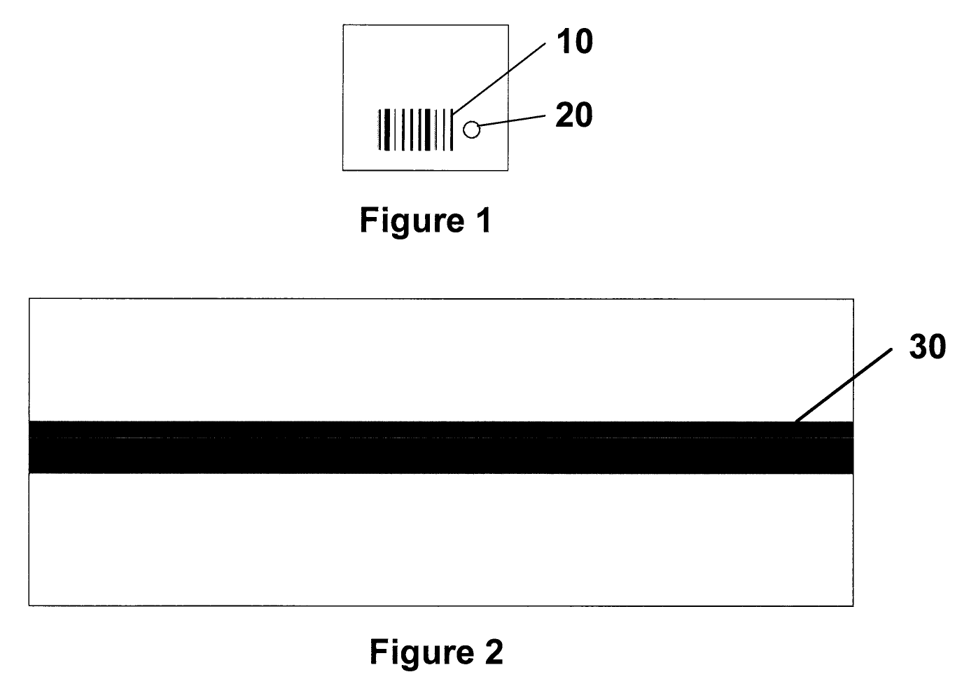

FIG. 1 illustrates exemplary packaging or a label with serial number 10 and target 20 including the fluorescent particles or other pigment/dye. The value corresponding to the serial number 10 can be combined with the value taken for the target 20 to produce a random machine-readable serial number for the packaging or label. The label can be read by a scanning device and provided via an internet enabled device to the label provider to confirm authenticity.

### Example 2

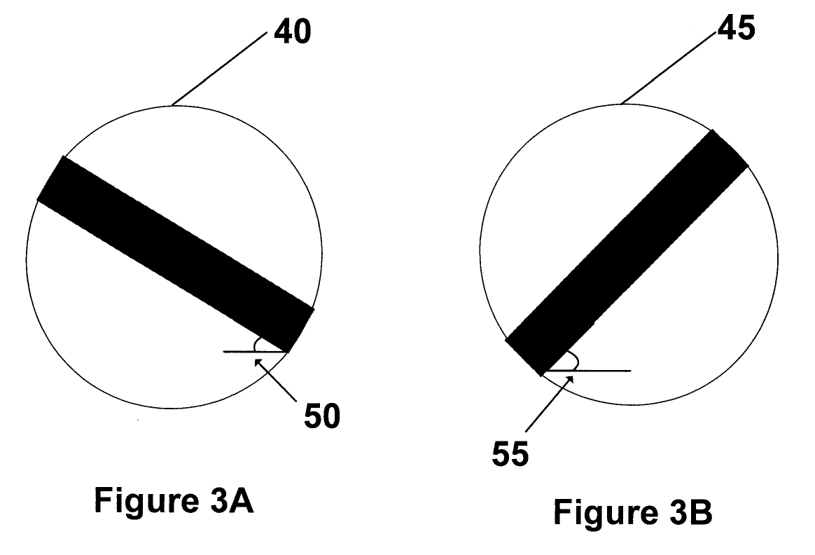

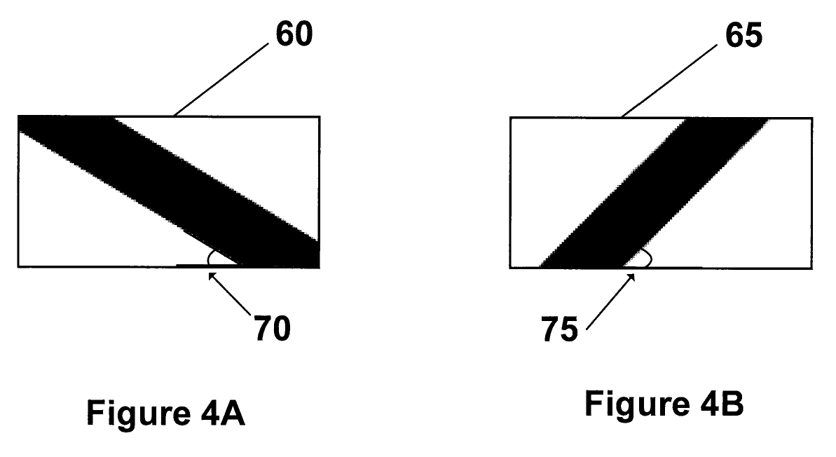

One or more stripes of a near visible pigment is placed on a sheet of a pressure sensitive adhesive label. FIG. 2 illustrates a single stripe 30 where the near visible pigment is shown as a visible pigment for illustration purposes. A visible pigment could alternately be used instead of the near visible pigment. The label can be die cut into circles 40 and 45 and spun randomly as shown in FIGS. 3A and 3B such that they are provided at particular angles 50 and 55. Alternately, as shown in FIGS. 4A and 4B, the label can be die cut into rectangles 60 and 65 provided at random angles 70 and 75.

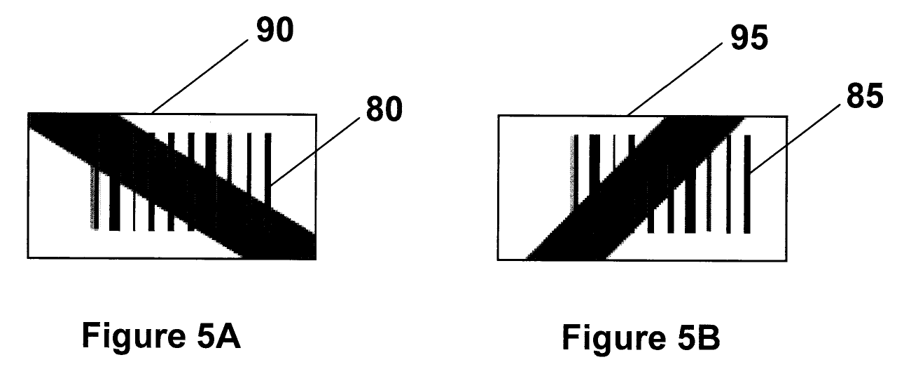

The angles 50 and 55 provided by the die cut circles 40 and 45 or the angles 70 and 75 provided by die cut rectangles 60 and 65 can be measured by an optical scanner and matched with a corresponding value. Bar codes 80 and 85 corresponding to particular serial numbers can be applied to the die cut shapes (e.g., the rectangles 60 and 65 illustrated in FIGS. 4A and 4B to produce the rectangles 90 and 95 in FIGS. 5A and 5B). The serial numbers for the bar codes 80 and 85 and the values of the angles 60 and 65 from FIGS. 5A and 5B can be paired in a database to provide a value for the near visible label. The labels 5A and 5B will appear as normal bar codes as the stripe is invisible to the naked eye when provided in the near visible range.

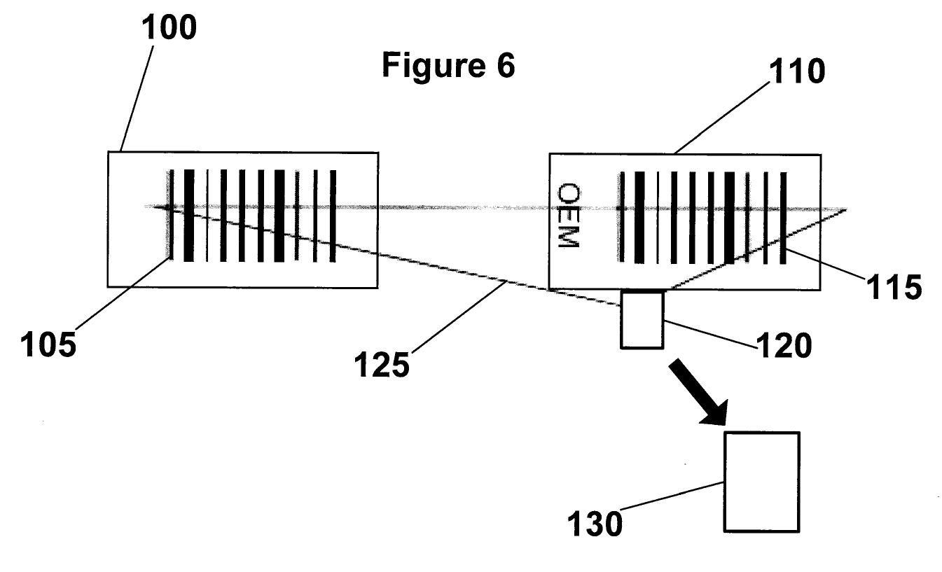

The labels such as rectangles with bar codes 90 and 95 can be sold by the label provider to an original equipment manufacturer (OEM) to be provided with a product. The label can be used in place of the OEM's standard bar code or along side the OEM's standard bar code. For example, as shown in FIG. 6, the label provider can provide a rectangular label 100 with a bar code 105 and near visible stripe (invisible to the naked eye and not shown) that is provided alongside the OEM's label 110 including the OEM's standard bar code 115, e.g., on packaging for a product. The serial number for the OEM's standard bar code 115, the serial number for the label provider's bar code 105 and the value corresponding to the angle for the near visible stripe can be indexed and made available in a database via a secure internet website.

The customer purchasing the product can use a device 120 to produce a scan 125 or an image such as a picture of the OEM label 110 and the rectangular label 100 from the label provider and upload the picture to the secure website. For example, a device 120 such as a cell phone camera capable of detecting a near visible pigment or a small scanner such as a Sony 4.5 mm diagonal CCD or a Hamamatsu 28×1 mm CCD can provide a scan or image of the OEM label 110 and the rectangular label 100. Software at the secure website can compare the OEM serial number from the bar code 115, the label provider serial number from the bar code 105, and the value corresponding to the angle of the rectangular label 100 to the values stored in the database on a server 130 connected via the internet. If all three values match the values in the database, the customer will receive an indication of a match. If any value does not match the value in the database, the customer will be notified of a counterfeit attempt. This allows the customer to authenticate the source of a product before purchase. Also, the OEM receives data when and where a counterfeiting attempt is happening in their market. The near visible marker is nearly impossible to fake thus making it difficult for a counterfeiter to perpetrate a false positive.

A number of embodiments have been described. Nevertheless, it will be understood to one skilled in the art that various modifications may be made. Further, while only certain representative combinations of the formulations, methods, or products are disclosed herein are specifically described, other combinations of the method steps or combinations of elements of a composition or product are intended to fall within the scope of the appended claims. Thus a combination of steps, elements, or components may be explicitly mentioned herein; however, all other combinations of steps, elements, and components are included, even though not explicitly stated.

The entire disclosure of each of the references that are cited in this disclosure is herein incorporated by reference.

What is claimed is:

1. A method of confirming that a product to be tested is a particular product, comprising:
providing an indicia having a measurable random physical property on the particular product or on packaging for the particular product, said indicia comprising photoactive, reflective or electromagnetic particles or combinations thereof, or one or more photoactive, reflective or electromagnetic films or substrates;
determining a value that corresponds to the random physical property of the indicia;
assigning the value to the particular product;
determining a value for the product to be tested using the method used in said previous determining step; and
comparing the value for the product to be tested to the value for the particular product to verify that the test product is the particular product.

2. The method of claim 1, further comprising:
shipping the particular product to a shipping location; and
determining the value for the product to be tested at the shipping location.

3. The method of claim 1, wherein the packaging for the individual product includes paper, flexible film or paperboard and the indicia is provided on or in the paper, flexible film or paperboard packaging of the individual product.

4. The method of claim 1, wherein associating the individual product with the indicia comprises providing the indicia on packaging for the individual product.

5. The method of claim 4, wherein said providing step comprising printing the indicia on the packaging for the individual product.

6. The method of claim 4, wherein associating the individual product with the indicia comprises providing the indicia on the individual product itself.

7. The method of claim 6, wherein said providing step comprising printing the indicia on the individual product.

8. The method of claim 6, wherein said providing step comprises coating the individual product with the indicia.

9. The method of claim 6, wherein said providing step comprises incorporating the indicia into the individual product.

10. The method of claim 4, wherein associating the individual product with the indicia comprises providing the indicia on a label that is to be attached to the individual product or to packaging for the individual product.

11. The method of claim 10, wherein said providing step comprises printing the indicia on the label.

12. The method of claim 1, wherein the indicia comprises photoactive, reflective or electromagnetic particles, or combinations thereof.

13. The method of claim 1, wherein the indicia comprises one or more photoactive, reflective or electromagnetic films.

14. The method of claim 13, wherein one or more photoactive, reflective or electromagnetic films include a nano-stratified film.

15. The method of claim 1, wherein the indicia comprises one or more photoactive, reflective or electromagnetic substrates.

16. The method of claim 1, wherein the indicia includes reflective particles.

17. The method of claim 16, wherein the reflective particles comprise hemispherically coated solid glass microspheres.

18. The method of claim 1, wherein the indicia includes photoactive particles.

19. The method of claim 18, wherein the photoactive particles comprise high aspect ratio pigments.

20. The method of claim 1, wherein the indicia includes electromagnetic particles.

21. The method of claim 20, wherein the electromagnetic particles comprise high aspect ratio, magnetically active particles.

22. The method of claim 1, wherein the indicia comprises one or more light reflective markings configured to have a random reflection wavelength.

23. The method of claim 1, wherein the indicia comprises one or more light reflective markings configured to have a random transmission wavelength.

24. The method of claim 1, wherein the indicia comprises one or more light reflective markings configured to have a random orientation.

25. The method of claim 1, wherein the indicia comprises one or more light reflective markings configured to have a random dimension.

26. The method of claim 1, wherein the indicia comprises one or more light reflective markings configured to have a random shape.

27. The method of claim 1, wherein the indicia comprises one or more light reflective markings configured to have a random number of regular and/or random shapes.

28. The method of claim 1, wherein the indicia comprises one or more light reflective markings configured to have a random color value.

29. The method of claim 1, wherein the indicia comprises one or more light reflective markings configured to have a random metamerism.

30. The method of claim 1, wherein the indicia comprises one or more light reflective markings configured to have a random distribution and/or concentration of reflective particles.

31. The method of claim 1, wherein the indicia comprises one or more light reflective markings configured to have a random distribution and/or concentration of misting fibers.

32. The method of claim 1, wherein the indicia comprises one or more light reflective markings configured to have random colors.

33. The method of claim 1, wherein the indicia comprises a fluorescent dye.

34. The method of claim 1, wherein said measuring step comprises scanning the indicia to produce the value corresponding to the random physical property of the indicia.

35. The method of claim 1, further comprising combining the measured value with one or more of a barcode, RFID tag or lot number to identify the individual product.

36. The method of claim 1, further comprising obtaining an image of an indicia to be verified, processing the image obtained to determine a value corresponding to a random physical property of the indicia to be verified, and comparing the value determined for the indicia to be verified to the measured value for the individual product for verification.

37. The method of claim 1, wherein the indicia includes a light reflective marking in the near infrared range.

38. A method of marking an individual product, comprising:
associating an individual product with an indicia having a measurable random physical property, said indicia comprising photoactive, reflective or electromagnetic particles or combinations thereof, or one or more photoactive, reflective or electromagnetic films or substrates;
measuring a value corresponding to the random physical property; and
assigning the measured value to the individual product.
